(19) United States
(12) Patent Application Publication
(10) Pub. No.: US 2022/0407999 A1
(43) Pub. Date: Dec. 22, 2022

(54) SYSTEM FOR CLEANING THE FRONT PANE OF A CAMERA HOUSING OF AT LEAST ONE SURVEILLANCE CAMERA UNIT

(71) Applicant: Dallmeier electronic GmbH & Co. KG, Regensburg (DE)

(72) Inventor: Dieter Dallmeier, Pettendorf (DE)

(21) Appl. No.: 17/753,275

(22) PCT Filed: Sep. 28, 2020
(86) PCT No.: PCT/EP2020/077045

§ 371 Date: Feb. 25, 2022

(30) Foreign Application Priority Data
Nov. 5, 2019 (DE) 20 2019 106 142.1

(51) Int. Cl. H04N 5/225; G02B 27/00; G03B 17/02

(52) U.S. Cl. CPC H04N 5/22521; G02B 27/0006; G03B 17/02; G08B 13/19619

(57) ABSTRACT

The invention relates to a system for cleaning the front pane of a camera housing of at least one multi-sensor camera unit. The system includes at least one multi-sensor camera unit with a camera housing having a front pane. At least one supply unit for the provision of a gaseous cleaning medium is provided, the supply unit being connected to at least one nozzle unit allocated to the front pane of the camera housing via at least one supply line, and wherein the at least one nozzle unit supplies the external surface of the front pane with the gaseous cleaning medium provided by the supply unit via the supply line.

### BACKGROUND OF THE INVENTION

The invention relates to a system for cleaning the front pane of a camera housing of at least one surveillance camera unit.

In the field of professional video surveillance of larger surveillance zones, high demands exist for the resolution of details of the recorded video data. The video surveillance systems used for this purpose comprise a plurality of surveillance cameras, which are set up specifically for the video surveillance of very diverse surveillance zones.

A surveillance camera unit comprises a preferably closed camera housing, in which the actual camera and its parts and/or components are accommodated. The camera housing comprises at least one front pane made of a transparent material, preferably glass or plastic, via which the surveillance zone can be detected by the camera accommodated in the housing, i.e. recordings of the surveillance zone can be created using the camera. Disadvantageously, such camera panes are subject to fouling, depending on the installation site of the camera. For example, the camera pane may be fouled by water droplets, dust, wind-borne sand, or cobwebs, which have the disadvantage of adversely impacting the quality of the recordings, in particular of video recordings.

Known from the existing art are systems for cleaning the front pane of a camera housing, which include at least one wiper unit via which the external surface of the camera pane can be cleaned by means of one or more wipers. A disadvantage of this is that the wipers or wiper blades frequently wear out and need replacement, thus further increasing the cost and effort of maintaining the surveillance camera. Another disadvantage is that the wipers or wiper blades may damage the camera pane surface in case of a fouling with solid dirt particles.

Also known from the existing art are video surveillance cameras with an enhanced detail resolution capacity, which have multiple image sensor units. Such cameras are also known as multi-sensor camera units. The camera head of such a multi-sensor camera unit comprises a plurality of image sensor units, wherein each image sensor unit comprises an objective and an associated image sensor, which preferably form a structural unit. The camera head of such a multi-sensor camera unit uses its image sensor units to scan different, generally slightly overlapping solid angle regions of a surveillance zone. Such multi-sensor camera units, therefore offer the advantage that, on account of the totality of the image content of all of the image sensor units, larger solid angles can be captured with a comparatively high resolution relative to the site of the surveillance zone (unit: pixels/meter at the distance x). Diverse manufacturers offer such multi-sensor camera units, which generate their image content using multiple image sensor units. Also here, the image sensor units are accommodated in a common camera housing comprising a front pane, which is subject to routine fouling.

### SUMMARY OF THE INVENTION

Based on this existing art, it is the object of the invention to specify a system for cleaning the front pane of a camera housing of at least one surveillance camera unit, which enables an easy, reliable, and low-maintenance cleaning of the front panes of surveillance camera units.

An essential aspect of the system for cleaning the front pane of a camera housing of at least one surveillance camera unit lies in that provision is made of at least one supply unit for providing a cleaning medium, the supply unit is connected to at least one nozzle unit allocated to the front pane of the camera housing via at least one supply line, wherein the at least one nozzle unit is designed to apply the cleaning medium provided by the supply unit via the supply line to the external surface of the front pane. By applying a cleaning medium to the front pane, a simple, reliable, and low-maintenance cleaning of the front pane is possible. The supply unit can also be advantageously set up to provide the cleaning medium to multiple surveillance camera units.

The front pane is also advantageously made of glass or of transparent plastic. The cleaning medium and the nozzle unit are advantageously adapted to the material used for the front pane.

At least one cleaning unit is particularly advantageously designed for dispensing the cleaning medium in the form of a cleaning medium jet. By dispensing the cleaning medium in a jet-like manner to the external surface of the front pane a wide-area cleaning of the same is possible. Furthermore, dirt particles adhering to the front pane can be effectively removed in this manner.

In a preferred embodiment variant, multiple nozzle units are provided, which preferably form one or more cleaning nozzle row(s). The nozzle unit(s) is/are at least partly accommodated or recessed in the camera housing. Particularly preferably, the nozzle unit(s) can be recessed in a front frame of the camera housing, which surrounds, and the front pane in a frame-like manner. By providing multiple nozzle units, even a wider front pane can be cleaned quickly, effectively, and reliably.

In a particularly preferred embodiment variant, the cleaning medium is gaseous. For example, the gaseous cleaning medium can be compressed air. A gaseous cleaning medium, in particular compressed air, has the advantage that the dirt particles are carried away in the compressed air stream, without cleaning medium leaving streaks on the front pane. Advantageously, at least one nozzle unit is then formed by at least one compressed air nozzle unit, and the supply line is formed by a compressed air line.

It is furthermore advantageous that the surveillance camera unit is formed by a video surveillance camera, in particular a multi-sensor camera unit. Particularly in the case of multiple image sensor units within the camera housing, an efficient cleaning of the front pane is compulsory in order to ensure sufficiently high image quality.

In an advantageous embodiment variant, the supply unit has at least one storage tank for containing the gaseous cleaning medium. Additionally, a control unit and at least one switch valve can be provided in the supply unit, which can be used to control the delivery of the gaseous cleaning medium to the storage tank and/or from the storage tank to the supply line.

The nozzle unit is preferably arranged in relation to the front pane in such a way that the cleaning medium strikes the front pane at an optimized or obtuse angle. The incidence angle is selected so as to achieve an optimum cleaning effect. If multiple nozzle units are provided, the latter can also be arranged such that each of the cleaning medium jets produced, strike the external surface of the front pane at different angles. The advantage of this is that larger surfaces can also be cleaned in a uniform and efficient manner.

Applying the cleaning medium to the external surface of the front pane can also be remotely controllable, for example by appropriate actuation of the supply unit via a link to a central control system.

Developments, advantages, and possible applications of the invention also emerge from the following description of exemplary embodiments and the figures. All described and/or illustrated features, either alone or in any combination, are in principle, the subject matter of the invention, regardless of how they are referenced or of how they are summarized in the claims. The content of the claims is also made a component of the description.

### BRIEF DESCRIPTION OF THE DRAWINGS

The invention is explained in more detail below, with reference to the figures and exemplary embodiments. Shown are:

FIG. 1 is a schematic, perspective view of a system for cleaning the front pane of the camera housing of a surveillance camera unit according to the invention.

FIG. 2 is a schematic functional block diagram of the system for cleaning the front pane of the camera housing of a surveillance camera unit according to the invention.

FIG. 3 is a schematic, perspective view of a system according to the invention comprising multiple surveillance camera units.

### DETAILED DESCRIPTION OF THE INVENTION

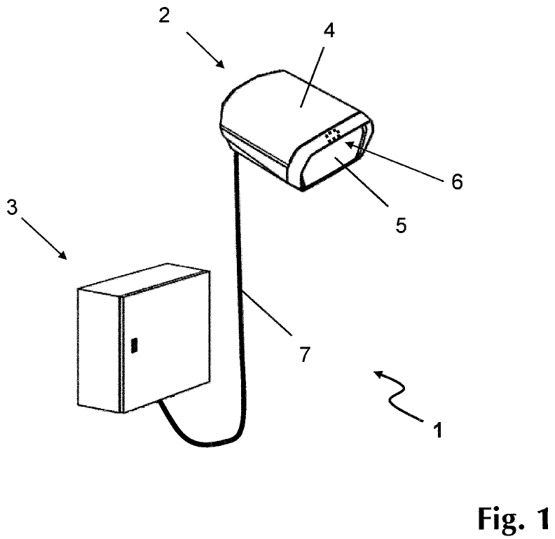

FIG. 1 shows a schematic, perspective view of a system 1 according to the invention comprising at least one surveillance camera unit 2 and at least one supply unit 3, wherein the surveillance camera unit 2 comprises a camera housing 4 with at least one front pane 5. The system 1 according to the invention is designed for cleaning the front pane 5 of the camera housing 4 of the at least one surveillance camera unit 2.

The surveillance camera unit 2 is preferably formed by a video surveillance camera, which is configured to make video recordings of a surveillance zone. The surveillance camera unit 2 is preferably embodied as a multi-sensor camera unit, which is equipped with multiple image sensor units (not shown in the figures) accommodated in the camera housing 4, wherein each image sensor unit comprises at least one objective and an associated image sensor, which preferably form a structural unit. Such a multi-sensor camera unit uses its image sensor units to scan different, generally slightly overlapping solid angle regions of a surveillance zone, wherein at least one of the image sensor units can also be provided for covering the entire surveillance zone. The totality of the image recordings captured by the different image sensor units results in a greater coverage angle, thus enabling recording of high-resolution video data (unit: pixels/meter at the distance x). However, the present invention is suitable for cleaning front panes 5 of surveillance camera units 2 of any design without deviating from the concept of the invention.

The front pane 5 of the camera housing is made of, for example, glass or transparent plastic, which is preferably accommodated in an end face opening in the camera housing 4.

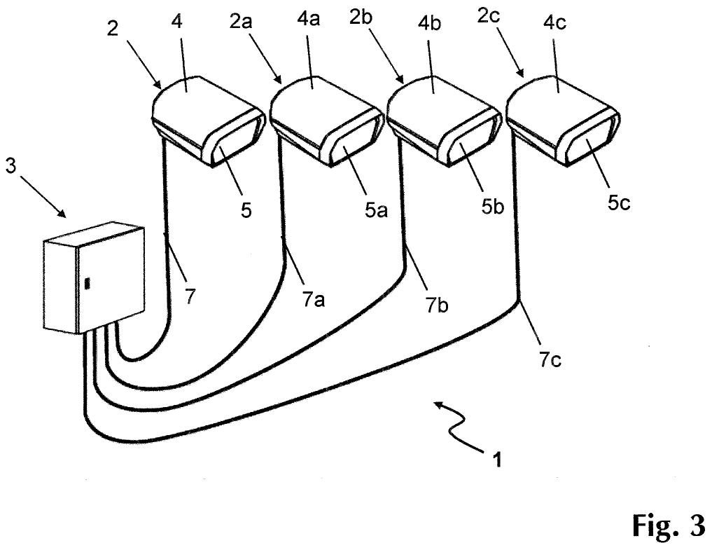

At least one supply unit 3 is provided for providing a cleaning medium RM. The unit preferably being spatially separated from the surveillance camera unit 2, for example, arranged at a non-central location. For example, a supply unit 3 can be configured to provide the cleaning medium RM to multiple surveillance camera units 2, 2a, 2b, 2c, as shall be explained in more detail further below using the embodiment variant according to FIG. 3 as an example.

Professional video surveillance systems for the video surveillance of larger surveillance zones often have a multiplicity of such video surveillance camera units 2, 2a, 2b, 2c, which are specifically configured for the video surveillance of very diverse surveillance zones and which are exposed to very diverse environmental conditions, depending on the area of application.

For providing the cleaning medium RM to at least one surveillance camera unit 2, or more precisely to the front pane 5 of the camera housing 4 of the at least one surveillance camera unit 2, a nozzle unit 6, which is connected to the supply unit 3 via at least one supply line 7, is allocated to the at least one front pane 5 of the camera housing 4. The nozzle unit 6 can either be at least partly accommodated in the camera housing 4 or can be recessed therein. Alternatively, at least one nozzle unit 6 can also be arranged upstream of the camera housing and/or at a distance from the same, namely in such a way that the nozzle unit 6 is aligned for applying the cleaning medium RM to the front pane 5 of the camera housing 4.

In FIG. 1, the nozzle unit 6 is indicated by a dotted-line symbol. In this exemplary embodiment, said unit is recessed in a front frame of the camera housing 4, which surrounds the front pane 5 in a frame-like manner. At least one nozzle unit 6 herein is designed to apply the cleaning medium RM, which is provided by the supply unit 3 via the supply line 7, to the external surface of the front pane 5. To this end, the cleaning medium RM is preferably applied over a wide area to the surface of the front pane 5 by the nozzle unit 6 in order to remove any dirt present on the front pane 5. For example, dirt such as water droplets, dust, wind-borne sand, and/or cobwebs can be removed quickly and easily from the front pane 5 by the cleaning medium RM.

Particularly preferably, the impact of the external surface of the front pane 5 takes place through a cleaning medium jet RMS generated by the nozzle unit 6, which for example strikes the external surface of the front pane 5 at an obtuse or optimized angle and thus picks up the dirt particles present thereon and removes them from the front pane 5. By providing multiple nozzle units 6, 6a, 6b, 6c, the cleaning medium jets RMS generated by the same can also have different incidence angles so as to enhance the cleaning effect further, in particular, to free larger surfaces from dirt in a uniform manner.

Use is preferably made of a gaseous cleaning medium RM, with particular preference being given to using compressed air for cleaning the front pane 5 of the surveillance camera unit 2. Accordingly, the nozzle unit 6 is then formed by a compressed air nozzle unit, and the supply line 7 is embodied as a compressed air line. The supply line 7 is furthermore hose-like, for example.

For providing the gaseous cleaning medium RM, in particular compressed air, the supply unit 3 has at least one storage tank 3.1 for containing the gaseous cleaning medium RM, which tank is accommodated in a preferably switch cabinet-like housing.

Furthermore, a control unit 3.2 and at least a first and a second switch valve 3.3, 3.4 are provided in the supply unit 3 or rather in the switch cabinet-like housing thereof, which are used to control the delivery of the gaseous cleaning medium RM to the storage tank 3.1 and from the latter to the supply line 7. To this end, the gaseous cleaning medium RM, preferably under a preset pressure, is supplied via an external delivery means under the control of the first switch valve 3.3 to the storage tank 3.1; i.e., the storage tank 3.1 is filled with the gaseous cleaning medium RM when the first switch valve 3.3 is opened, the delivery taking place under the preset pressure. The first switch valve 3.3 connects the external delivery means to the storage tank 3.1. The supply line 7 is in turn connected to the storage tank 3.1 via the second switch valve 3.4. A supply of the gaseous medium RM, the level of which is preferably such that it suffices for several cleaning cycles, can be built up under pressure in the storage tank 3.1.

For example, the storage tank 3.1 is filled with compressed or pressurized air having a pressure of ca. 6-10 bar, preferably 8 bar. The cleaning medium RM, which is stored under pressure in the storage tank 3.1, is then discharged to the supply line 7 under the control of the control unit 3.2. The discharge can take place, for example, during a preset time interval and/or in an intermittent or pulse-like fashion.

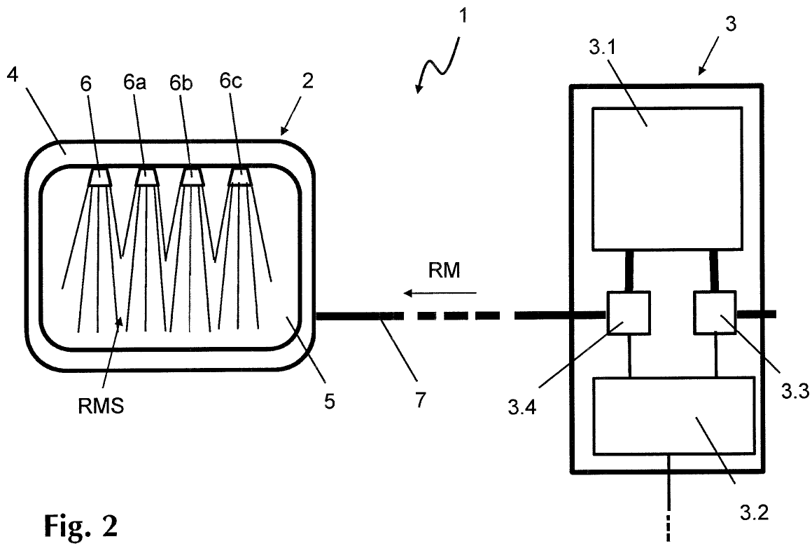

The control unit 3.2 of the supply unit 7 can also be connected to a master control system of a surveillance facility via a data interface, for example via an ethernet interface. A remote control of the cleaning system 1 according to the invention is thus achievable via the master control system. The discharge can be controlled via, for example, a second switch valve 3.4. To this end, the control unit 3.2 is connected to the first as well as to the second switch valve 3.3, 3.4, as illustrated in FIG. 2.

According to the embodiment variant illustrated in FIG. 2, multiple nozzle units 6, 6a, 6b, 6c are provided in the camera housing 4 of a surveillance camera unit 2, which are preferably arranged in a row and thus form a cleaning nozzle row. The cleaning nozzle row herein extends along an edge of the front pane 5. For example, a first through fourth nozzle unit 6, 6a, 6b, 6c, are provided which are supplied with the cleaning medium RM via a common supply line 7. The first through fourth nozzle units 6, 6a, 6b, 6c can in turn be accommodated or recessed in a front frame of the camera housing 4. It is clear that nearly any number of nozzle units 6, 6a, 6b, 6c can be arranged in one or more rows without deviating from the concept of the invention. For example, between 4 and 12 nozzle units 6 for cleaning the front pane 5 can be provided in a camera housing 4 of a surveillance camera unit 2.

FIG. 3 shows still another embodiment variant of the system 1 according to the invention comprising multiple surveillance camera units 2, 2a, 2b, 2c, which are each connected to the supply unit 3 via a dedicated supply line 7, 7a, 7b, 7c. The surveillance camera units 2, 2a, 2b, 2c are each supplied with the cleaning medium RM separately from one another, preferably in sequence, via the respective supply lines 7, 7a, 7b, 7c. The line lengths of the supply lines 7, 7a, 7b, 7c can be up to 10 m, for example.

The invention was described in the preceding with reference to exemplary embodiments. Obviously, numerous changes and modifications are possible without deviating from the inventive concept underlying the invention.

### LIST OF REFERENCE SIGNS

1 System
2, 2a, 2b, 2c Surveillance camera unit(s)
3 Supply unit
4, 4a, 4b, 4c Camera housing
5, 5a, 5b, 5c Front pane(s)
6, 6a, 6b, 6c Nozzle unit(s)
7, 7a, 7b, 7c Supply line(s)
RM Cleaning medium
RMS Cleaning medium jet

1. A system for cleaning a front pane of a camera housing of at least one multi-sensor camera unit, the system comprising:
at least one multi-sensor camera unit with the camera housing having the front pane, wherein at least one supply unit for providing a gaseous cleaning medium (RM) is provided, the at least one supply unit is connected to at least one nozzle unit allocated to the front pane of the camera housing via at least one supply line, and wherein the at least one nozzle unit applies a gaseous cleaning medium provided by the at least one supply unit via the at least one supply line to an external surface of the front pane, wherein multiple nozzle units are provided, the multiple nozzle units form one or more cleaning nozzle rows, in that at least one of the multiple nozzle units are at least partly accommodated in the camera housing and recessed in a front frame of the camera housing which surrounds the front pane in a framed manner, wherein the supply unit is configured to provide the gaseous cleaning medium to multiple surveillance camera units.

2. The system according to claim 1, wherein the front pane is made of glass or of a transparent plastic.

3. The system according to claim 1, wherein the at least nozzle unit delivers the gaseous cleaning medium in the form of a cleaning medium jet.

4. The system according to claim 1, wherein the gaseous cleaning medium is compressed air.

5. The system according to claim 4, wherein the at least one nozzle unit is formed by at least one compressed air nozzle unit and the supply line is formed by a compressed air supply line.

6. The system according to claim 1, wherein the at least one supply unit comprises a least one storage tank for containing the gaseous cleaning medium.

7. The system according to claim 6, further comprising a control unit and at least one switch valve, which is used to control a delivery of the gaseous cleaning medium to the at least one storage tank and/or to control a delivery from the at least one storage tank to the at least one supply line, and the control unit and the at least one switch valve are provided in the at least one supply unit.

8. The system according to claim 1, wherein the at least one nozzle unit is arranged with respect to the front pane in such a way that the gaseous cleaning medium strikes the front pane at an obtuse angle.

9. The system according to claim 1, wherein an application of the gaseous cleaning medium to an external surface of the front pane is controlled remotely.
